(19) United States
(12) Patent Application Publication
(10) Pub. No.: US 2014/0174551 A1
(43) Pub. Date: Jun. 26, 2014

(54) Variable Gas Pressure Regulator

(71) Applicant: Westport Power Inc., Vancouver (CA)

(72) Inventor: Michael McKay, Kardinya (AU)

(21) Appl. No.: 14/192,690

(22) Filed: Feb. 27, 2014

Related U.S. Application Data
(63) Continuation of application No. PCT/CA2012/050595, filed on Aug. 28, 2012.

(51) Int. Cl. G05D 16/06

(52) U.S. Cl. CPC G05D 16/063
USPC 137/12; 137/494

(57) ABSTRACT

A variable gas pressure regulator comprises a throttling valve regulating the fluid flow between a high-pressure fluid inlet and a regulated space fluidly connected to a fluid outlet, a high-pressure solenoid commanded to control fluid flow between the fluid inlet and a control space and a low-pressure solenoid commanded to control fluid flow between the control space and the regulated space. The regulator achieves a variable pressure at the regulator outlet by commanding the two solenoids to control the pressure in the control space relative to the regulated space. The regulator further comprises a lock-off valve which is controlled by the action of the low-pressure solenoid and of the high-pressure solenoid based on the relative pressure difference between the control space and the regulated space. The lock-off valve seals the passage between the fluid inlet and the regulated space.

### CROSS-REFERENCE TO RELATED APPLICATIONS

This application is a continuation of International Application No. PCT/CA2012/050595 having an international filing date of Aug. 28, 2012 entitled “Variable Gas Pressure Regulator”. The '595 international application claimed priority benefits, in turn, from Australian Patent Application No. 2011903466 filed on Aug. 29, 2011. The '595 international application is hereby incorporated by reference herein in its entirety.

### FIELD OF THE INVENTION

The present invention relates to an improved variable pressure regulator for controlling, for example, the gas pressure supplied to an engine using gaseous fuels. Typically, the gas is compressed natural gas (CNG).

### BACKGROUND OF THE INVENTION

Referring to FIG. 1, conventional regulators for a similar application, so called on-demand regulators, are typically based on the principle of providing a throttling valve 1 connected between an upstream inlet port 2 containing the source of pressurized gas and a downstream chamber 3 containing the regulated gas at the regulated pressure, from which gas can flow through an exit port 4 to the required destination.

An on-demand regulator has a control member 5 controlling throttling valve head 6 acted upon by diaphragm 7 responsive to the differential pressure across diaphragm 7 acting in a first direction and a spring 8 providing a force loading acting in the opposite direction, the spring force acting so as to normally open throttling valve 1 when the pressure in regulated space 3 is low. Typically, one side of diaphragm 7 is exposed to and responsive to the regulated pressure acting in a direction on control member 5 whereby diaphragm 7 tends to close off throttling valve 1 if the regulated pressure exceeds a certain pressure as set by the spring loading. The spring force acts in an opposite direction to the net pressure force on diaphragm 7 due to the pressure in the regulated space 3. Thus, when there is no source of high-pressure gas present at inlet port 2, throttling valve 1 is normally open in this condition. Throttling valve 1 closes when the forces generated by the pressure in regulated space 3 exceed a certain pre-determined level of pressure defined by the pre-load of spring 8.

The disadvantage of such a regulator for CNG applications is that the upstream source of high-pressure gas varies over a very large range of pressures at inlet 2 as the supply tank is filled and then discharged over time in normal service. This imposes a large range of pressure forces acting across throttling valve head 6 as the pressure varies from maximum to minimum as the tank is emptied after being filled. Because the regulated pressure depends on the equilibrium of the gas forces on both diaphragm 7 and throttling valve head 6 in equilibrium with the fixed load provided by spring 8, the actual regulated pressure in regulated space 3 varies in accordance with the supply pressure in inlet duct 2. This is due to the variation in the throttling forces as the supply pressure changes. This effect is reduced or minimized by providing a large area of diaphragm 7 relative to the size of throttling valve 1.

Additional to the variation in the throttling forces, the spring force also changes as spring 8 is compressed or relaxed as throttling valve head 6 moves to a different position of equilibrium as the gas flow changes in response to differing demands of regulated gas flow. This change in force is due to the inherent and characteristic stiffness of spring 8 where the spring force varies with the position of valve head 6. Therefore, the regulated pressure tends to vary with the flow rate rather than stay constant for a given nominal spring setting. A reducing pressure characteristic with increasing flow as measured at the destination of the gas flow is exacerbated by the pressure drop across the exit port and its extensions on the way to the destination where the regulated pressure can be typically measured.

A serious flaw of such a regulator is that there is typically a large pressure force acting across diaphragm 7. In addition, if the diaphragm should rupture in service, gas can escape across diaphragm 7, creating a potential fire hazard as it escapes through reference port 9 of FIG. 1. Typically, reference port 9 might be connected to the inlet manifold of an engine in an application using CNG as a fuel. Otherwise, it can be connected to the atmosphere. Gas leaking from reference port 9 and passing to the intake manifold of an engine represents additional fuel that may force higher combustion temperatures that can be destructive to an engine, particularly if detonation is induced before the control system can either correct this condition or elicit a response from the human operator of such an engine using an electronic warning system.

In addition, throttling valve 1 tends to open in response to the rupture of diaphragm 7 due to the changed equilibrium of forces acting on control member 5, allowing the regulated pressure to rise about the nominal regulated value, sometimes to a dangerous level where the operation of a safety relief valve is necessary to dump high pressure gas to the atmosphere. If CNG gases are vented to the atmosphere they represent an undesirable emission of a gas contributing to the well-known greenhouse effect in the atmosphere. Also, the operation of the gas metering system and the engine management system can be compromised under such conditions, resulting in the shutdown of an engine and its subject vehicle, often in an inconvenient location and strategic situation in a busy traffic system. In an extreme case, a severe fire hazard may exist if regulations have not been complied with.

A further limitation of the conventional on-demand regulator is that the pressure setting is relatively fixed by virtue of the relatively fixed spring force acting on the diaphragm. It is convenient for an engine running on CNG for the pressure of the gas supplied to gas metering injectors to be variable so that, for example, a low pressure can be set by the engine control system at engine idle and a high pressure be set at full engine load. The metering accuracy of a gas injector can be better managed or optimized by such an arrangement while potentially allowing for a better matching of the gas flow relative to the airflow of the engine.

A further disadvantage of the conventional regulator defined in FIG. 1 is the fact that throttling valve 1 is normally open when the gas pressure in inlet 2 is low. In practice, and in reference to an engine that is being started, it is common that a gas supply at high pressure is suddenly applied to inlet 2 by an external valve upstream of inlet 2 and this tends to result in the regulated pressure in regulated space 3 temporarily exceeding the normal regulated pressure. This is due to the relatively slow response of the assembly as it acts to close throttling valve 1 in response to the rapidly rising gas pressure at inlet 2. This tends to result in high stresses on throttling valve 1, on control member 5 and on diaphragm 7.

### SUMMARY OF THE INVENTION

A variable gas pressure regulator is disclosed for regulating the pressure of a gas supplied from a high pressure gas supply to a user. The variable gas pressure regulator comprises:
(a) a body provided with an inlet and an outlet;
(b) a control space and a regulated space, the regulated space being fluidly connected to the outlet and being separated from the control space by a diaphragm;
(c) a throttling valve operable to regulate fluid flow between the inlet and the outlet;
(d) a control member associated with the diaphragm to move in response to movements of the diaphragm, the control member being movable to operate the throttling valve; and
(e) a lock-off valve associated with the control member and located in a fluid flow path between the throttling valve and the regulated space, wherein the lock-off valve stops flow of fluid from the inlet to the regulated space when the throttling valve is closed.

The variable gas pressure regulator also comprises a first electronically activated valve for controlling flow of fluid from the inlet to the control space and a second electronically activated valve for controlling flow of fluid from the control space to the regulated space.

The variable gas pressure regulator further comprises a spring mechanism which acts on the diaphragm to move the control member against the pressure force of the fluid in the control space when the pressure in the control space equals the pressure in the regulated space, whereby the throttling valve and the lock-off valve are urged to their respective closed positions.

The variable gas pressure regulator further comprises a high-pressure solenoid which is actuated to open or close the first electronically actuated valve and a low-pressure solenoid which is actuated to open or close the second electronically actuated valve.

In the present variable gas pressure regulator the first electronically actuated valve or its associated fluid passage has a cross-sectional fluid flow area that is at least 10 times bigger than the cross-sectional fluid flow area of the second electronically actuated valve or its associated fluid passage.

In some embodiments, the present variable gas pressure regulator can comprise a heating gallery through which a heating fluid can circulate close to the throttling valve to inhibit or prevent the freezing of the gas pressure regulator.

In other embodiments, the variable gas pressure regulator can comprise an electrical heating element located close to the throttling valve to inhibit or prevent freezing of the gas pressure regulator fluid.

Preferably, the throttling valve comprises at least one component made of a metallic material. The lock-off valve preferably comprises a resilient seal for sealing a fluid passage between inlet and the regulated space.

A method is provided for operating a variable gas pressure regulator comprising an inlet, an outlet, a control space and a regulated space which is fluidly connected to the outlet and separated by a diaphragm from the control space. The method comprises:
(a) increasing the pressure in the control space by periodically actuating a first electronically activated valve to open fluid flow between the inlet and the control space thereby moving the diaphragm and a control member associated with the diaphragm to open a throttling valve and a lock-off valve which are associated with the control member to open fluid flow between the inlet and the outlet; and
(b) regulating fluid flow between the inlet and the outlet by actuating a second electronically activated valve to temporarily open fluid flow from the control space to the regulated space if the pressure in the regulated space exceeds a predetermined pressure thereby urging the throttling valve and the lock-off valve towards their respective closed positions.

In its closed position, the lock-off valve further stops the flow of fluid from the inlet to the regulated space when the throttling valve is closed.

In the present method, the fluid flow rate through the throttling valve and through the lock-off valve is determined by the position of the control member.

In the present method, the second electronically activated valve opens when the pressure in the control space exceeds a predetermined limit to allow fluid flow from the control space to the regulated space.

### BRIEF DESCRIPTION OF THE DRAWINGS

FIG. 1 illustrates a conventional on demand pressure regulator.

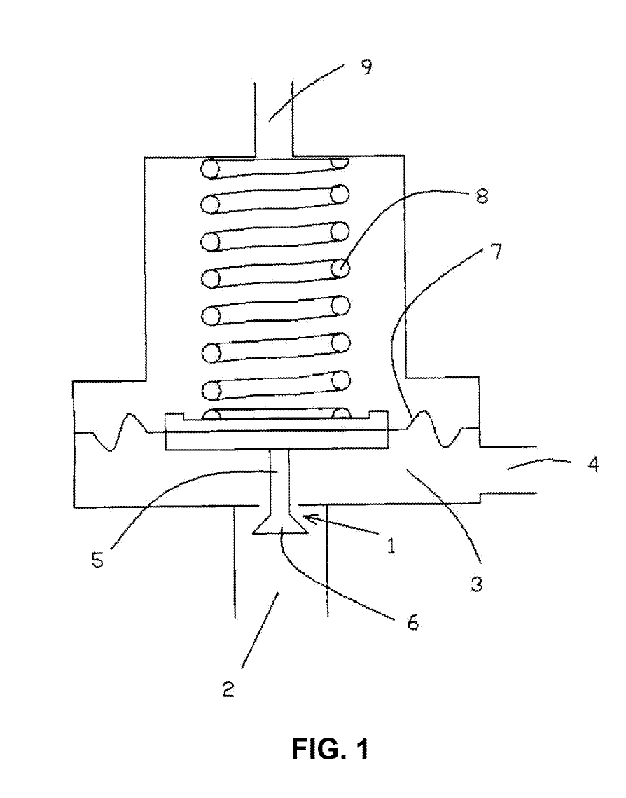

FIG. 2 shows a schematic illustration of the preferred embodiment of a variable gas pressure regulator comprising a throttling valve and a lock-off valve for regulating the pressure at the outlet wherein the throttling valve and the lock-off valve are illustrated in their closed position.

FIG. 3 shows a schematic illustration of the same preferred embodiment of a variable gas pressure regulator shown in FIG. 2 but also showing the outlet connected to a delivery duct and with the throttling valve and the lock-off valve illustrated in their open position. Like components are referred to in the disclosure by the same reference numbers, though not shown in FIG. 3.

### DETAILED DESCRIPTION OF PREFERRED EMBODIMENT(S)

The disclosed variable pressure regulator is capable of achieving a variable pressure at the outlet by actuating a high-pressure solenoid and a low-pressure solenoid which are operable to control the pressure in a control space relative to a regulated space.

In preferred embodiments, the variable pressure regulator is used for controlling the gas pressure supplied to an engine using gaseous fuels. The gas is preferably compressed natural gas (CNG), but it can be another gaseous fuel such as hydrogen, propane, ethane, butane, methane, and mixtures thereof. The operation of the present variable pressure regulator will now be described for regulating the pressure of a gas that is delivered from a gas supply to a user that can be, for example, a gaseous fuelled engine. Such a variable pressure regulator can be used for other gaseous fluids and at a wide range of pressures.

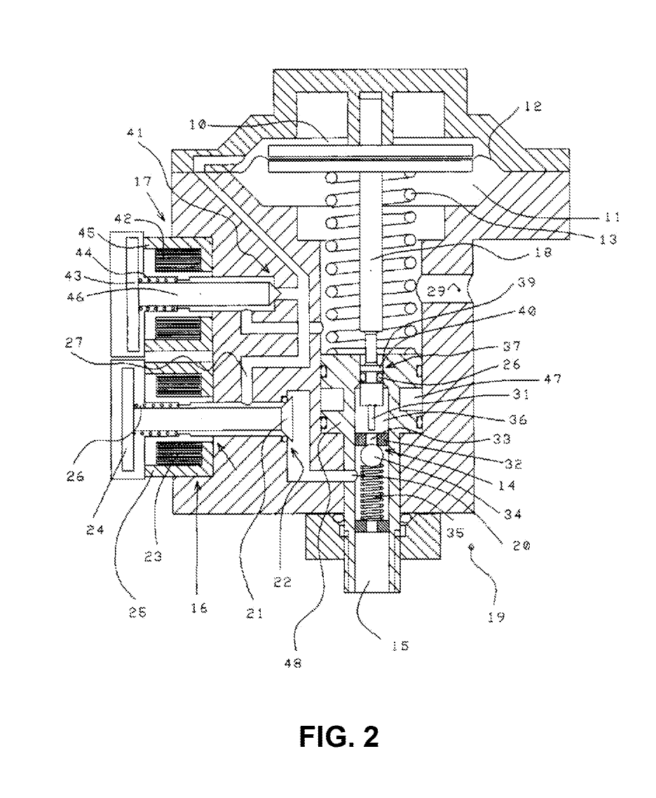

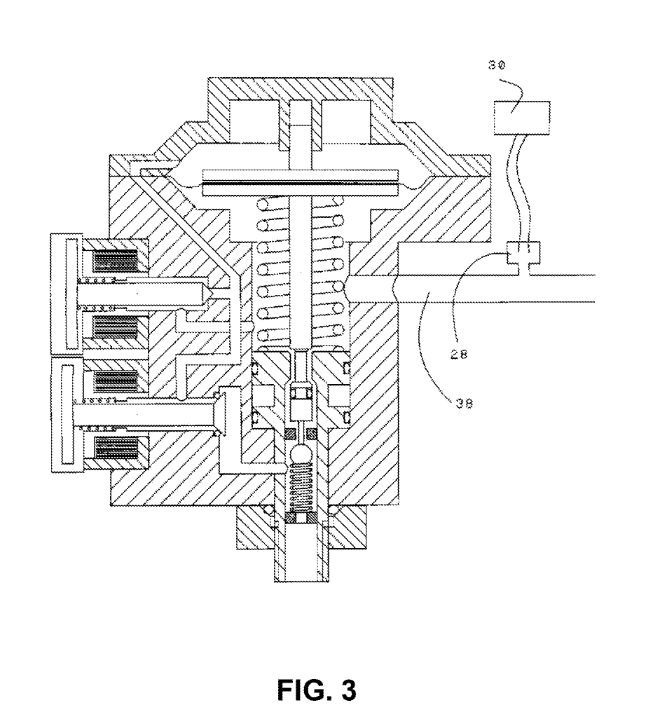

With reference to FIGS. 2 and 3, a method of regulation is provided whereby the spring force of a conventional regulator is replaced on one side of diaphragm 12 by a force generated by the pressure in control space 10 acting to oppose the regulating pressure force acting on the other side of diaphragm 12, the other side of the diaphragm being responsive to the pressure in regulated space 11. The pressure in control space 10 replaces the force provided by the spring of a conventional regulator, substantially reducing the pressure difference between one side of the diaphragm and the other. In this case, the pressure in control space 10 substantially defines the regulated pressure setting while substantially reducing the forces acting to rupture diaphragm 12.

Additionally, there is provided a spring 13 acting to produce a force tending to normally close throttling valve 14 acting in parallel with and in the same direction as the gas forces on throttling valve 14, tending to act together to close throttling valve 14 and opposing the pressure forces in control space 10 relative to the pressure forces in regulated space 11. Typically, spring 13 provides a relatively low force and has low stiffness.

The disclosed variable pressure regulator creates the reference pressure in control space 10 using both a high-pressure (HP) solenoid 16 connected to control flow between high-pressure inlet 15 and control space 10 in a first aspect, and a low-pressure (LP) solenoid 17 connected to control flow between control space 10 and regulated space 11 in a second aspect, both solenoids being actuated in order to control the pressure in control space 10 relative to regulated space 11, using the following means:
(a) directing gas from high pressure supply 15 to first HP solenoid 16 that is normally closed to gas flow, thereby inhibiting or preventing the flow of HP gas to the communicating control space 10 downstream of HP solenoid 16;
(b) periodically opening HP solenoid 16 to admit a discrete mass of gas from HP supply 15 to control space 10;
(c) monitoring the resulting regulated pressure in regulated space 11 or its extensions so as to provide a certain specified reference pressure in regulated space 11 or its extensions by comparing the resulting regulated pressure with a pre-determined reference pressure set by controller 30 measuring the pressure in regulated space 11 or its extensions using a pressure transducer 28;
(d) ceasing to admit gas flow from HP solenoid 16 when the reference pressure set by controller 30 is exceeded in regulated space 11 by a pre-determined margin;
(e) periodically opening low pressure LP solenoid 17 connected to control space 10, the LP solenoid being held normally closed to gas flow by electromagnetic forces, the periodical opening being so as to allow a discrete mass of gas to be directed from control space 10 to regulated space 11 for the purposes of reducing the relative pressure between control space 10 and regulated space 11 if the pressure in regulated space 11 should exceed the reference pressure by a margin pre-determined by the controller;
(f) maintaining the pressure in the regulated space by repeatedly transferring the discrete masses of gas using the appropriate solenoid in order to maintain the reference pressure within the bounds set by the controller;
(g) providing means for shutting down the flow of gas through regulator 19 by providing substantial equilibrium in pressure between control space 10 and regulated space 11 by opening the LP solenoid to flow between the respective spaces and providing a force from spring 13 acting on control member 18 and connected to diaphragm 12, the diaphragm 12 being interposed between control space 10 and regulated space 11 acting to close lock-off valve 37 interposed between inlet 15 and regulated space 11.

The regulator configures LP solenoid 17 in a configuration such that valve port 41 of LP solenoid 17 is normally closed while a defined current is flowing continuously in solenoid coil 42 generating an electromagnetic force on armature 43 and linking magnetic pole 45 so as to oppose both the pressure forces acting across valve port 41 and the force of spring 44. Valve port 41 is normally open when no current is flowing continuously in solenoid coil 42, the gas flow allowing substantial equilibrium in pressure to occur between control space 10 and regulated space 11 while the HP solenoid 16 is closed to flow for an extended period, thereby allowing spring 13 to lift control member 18 and close lock-off valve 37 when there is a low level of current in coil 42 and correspondingly lower magnetic flux linking armature 43 and magnetic pole 45, or when there is no source of electrical power providing current to the coil 42. Meanwhile, spring 35 and the throttling pressure forces acting on throttling valve 14 press the throttling valve against valve seat 32.

It is a further aspect of the present regulator to provide a HP solenoid 16 in a configuration whereby valve port 22 of HP solenoid 16 is normally closed when there is a low flow of current in coil 23 and solenoid valve port 22 is held in sealing closure by the pressure forces normally provided from high pressure supply 15, and to provide means whereby the pressure forces across valve port 22 are periodically overcome by opposing electromagnetic forces in armature 24 and magnetic pole 25 when current is flowing in coil 23 of solenoid 16, allowing valve port 22 to open against the pressure forces across valve port 22 so as to allow the flow of gas from HP supply 15 to control space 10 while such current flows in coil 23 of HP solenoid 16.

By this mechanism, regulator 19 has low net forces acting across diaphragm 12 that controls throttling valve 14 interposed between inlet 15 and regulated space 11, the opening of throttling valve 14 being responsive to the relative pressures in control space 10 and regulated space 11, together with the action of spring 35 acting in such a direction as to urge closure of throttling valve 14.

In this arrangement, the compliance of control member 18 is high and the mechanical stiffness is low, allowing for high responsiveness to a change in the equilibrium of control member 18, particularly due to pressure changes in regulated space 11 or control space 10. Furthermore, the regulated pressure can be conveniently controlled to a different pressure by controlling solenoids 16 and 17 in response to an instantaneous requirement of the engine control system. At the same time, regulator 19 is intrinsically safe because the rupture of diaphragm 12 does not result in the leakage of gas to the exterior of regulator 19. Furthermore, when all power to solenoids 16 and 17 is removed, throttling valve 14 will close in response to this condition by virtue of the substantial equilibrium of the pressure forces thereby established across diaphragm 12 upon the opening of valve port 41 of LP solenoid 17 to allow gas flow between control space 10 and regulated space 11. Also, HP solenoid 16 allows a significant overpressure to be supplied on the supply side of the regulator without the uncontrolled release of gas under such conditions.

The operation of the variable pressure regulator is described in a more detailed description, referring now to FIG. 2. Inlet port 15 is connected to a source of high pressure gas and a high pressure bleed port 20 allows gas to communicate with valve head 21 normally sealing high pressure port 22 of high pressure solenoid 16. When coil 23 of HP solenoid 16 is energized by current flow, armature 24 is attracted towards pole 25 due to the linkage of magnetic flux created by the electrical current in coil 23, the attractive magnetic force overcoming both the force of spring 26 and the gas pressure across valve head 21 that normally holds valve head 21 in sealing relationship with the seat of port 22, thereby opening port 22 and allowing gas to flow from inlet 15 through bleed port 20 and past open port 22, and ultimately into control space 10 through duct 27.

Referring to FIG. 3, pressure transducer 28 can be connected to delivery duct 38 communicating with regulated space 11. A controller 30 monitoring the pressure in regulated space 11 or its extensions can curtail the current in coil 23, resulting in port 22 closing by virtue of the forces in spring 26, aided by pressure forces on valve head 21 tending to increase the sealing of port 22.

The regulation provided by throttling valve 14 occurs as follows.

Referring to FIG. 3 illustrating the normal position of control member 18 of FIG. 2 when flow is occurring, and when the pressure in control space 10 increases in response to the flow of gas admitted by HP solenoid 16, the resulting pressure force on diaphragm 12 acts on control member 18 and overcomes the relatively lower force of spring 13 and the pressure force in regulated space 11. Pushrod 31 connected to control member 18 passes through seat 32 defining part of regulation port 33 that is normally closed to gas flow from inlet 15 by virtue of valve element 34 being forced into closed relationship with seat 32 by both spring 35 and the gas pressure forces acting on valve element 34. When forced by pushrod 36, valve element 34 is moved from seat 32 and gas can then flow into intermediate space 36 and past the open lock-off valve 37 into regulated space 11. When the pressure in regulated space 11 rises so that the gas pressure forces across diaphragm 12 and the force from spring 13 are in equilibrium with the gas pressure forces on diaphragm 12 from the control space 10, control member 18 and pushrod 31 move further towards closure of throttling valve 14, thereby defining a defined regulated pressure in regulated space 11 and in exit port 29 and its extensions in delivery duct 38 illustrated in FIG. 3.

Referring to FIG. 2, it is an aspect of this regulator to provide a secondary lock-off valve 37 in the path between throttling valve 14 and regulated space 11 comprising of a bore 39 through which grooved valve head 40 is in cooperation with control member 18 and is in sealable relationship with bore 39 due to seal 26 in the groove of valve head 40. Lock-off valve 37 is primarily controlled by the action of LP solenoid 17 and HP solenoid 16 which control the relative pressure difference between control space 10 and regulated space 11, together with the forces from the spring 13 to determine the axial position of the control member 18.

In normal active operation, and referring also to FIG. 3, when gas is flowing from inlet 15 through throttling port 14 and past open lock-off valve 37 into regulated space 11 and out of exit port 29, LP solenoid 17 has its valve port 41 held closed. This is by virtue of current flow in coil 42 acting to attract armature 43 towards pole 45 against the force of spring 44 and the gas pressure forces acting on valve member 46 sealing on valve port 41 connected on the upstream side to intermediate duct 27 in communication with both control space 10 and the downstream side of HP solenoid 16. This operating condition will occur with an elevated pressure in control space 10 relative to that in regulated space 11 due to the periodic action of the aforementioned HP solenoid 16 and closed port 41 of LP solenoid 17.

Referring also to FIG. 3, when control unit 30 acts to shut down the flow of gas from regulator 19 to switch to the position shown in FIG. 2, the current in coil 42 of LP solenoid 17 is reduced or turned off completely, allowing the combined force of spring 44 and the pressure forces across port 41 acting on valve member 46 to open port 41, allowing gas to flow from control space 10 to regulated space 11, thereby allowing substantial equilibrium in pressure across diaphragm 12. This substantial equilibrium in pressure and the combined action of spring 13 and the throttling pressure forces across throttling valve 14 and valve head 40 act to close lock-off valve 37 and force valve head 40 into sealed relationship with bore 39 by virtue of seal 26. In this way, for given respective pressures in control space 10 and regulated space 11, the substantial equilibrium in the respective pressures is provided by the action of LP solenoid 17, and closure of lock-off valve 37 is provided for a given level of static pressure that can initially exist in either or both of control space 10 and regulated space 11.

Lock-off valve 37 has a flexible seal 26 that will reduce leakage into regulated space 11 when regulator 19 is shut down by control unit 30. Also, lock-off valve 37 can allow the regulation of the gas flow when the flow rate is extremely small and where main throttling valve 14 can have high enough leakage when closed to preclude effective regulation at such a low rate of gas flow.

Conveniently, throttling valve 14 can be a fully metallic valve to promote precise flow characteristics and good heat transfer from a heating fluid in heating gallery 47, the flow being conveniently circulated from a fluid flow associated with an operating engine providing waste heat to a circulated fluid in heating gallery 47. An electrical heating element can be used as an adjunct to or in addition to the heated fluid circulated in the heating gallery 47. The arrangement of a valve carrier 48 surrounding the throttling valve 14 promotes good heat transfer to valve seat 32 and intermediate duct 36 so as to inhibit or prevent the formation of ice as the gas flow is throttled across throttling valve 14 and drops in temperature due to its expansion into intermediate space 36. This arrangement also inhibits or avoids extreme cooling of flexible seal 26, which might be otherwise susceptible to hardening at extremely low temperatures.

The present method of pressure regulation allows a wide range of pressures to be set very accurately independently of the flow rate and restrictions in the flow path through regulator 19 and delivery duct 38. Also, the regulated pressure can be set almost instantaneously and maintained automatically by the control system in response to a number of variables related to the operation of an engine, for example.

For an example of a pressure limiting device acting on control space 10, LP solenoid 17 of this regulator is also intrinsically a safety relief valve controlling the relief of excessive gas pressure between control space 10 and regulated space 11. The relief pressure is determined in this case by the pressure acting across port 41 acting on valve member 46 in parallel to the force of spring 44 and opposing the electromagnetic force of attraction between armature 43 and magnetic pole piece 45. When the pressure force and the force of spring 44 is large enough to overcome the aforementioned electromagnetic force, port 41 will be open to gas flow, thereby relieving excess pressure in control space 10 relative to regulated space 11. In turn, this electromagnetic force can be programmed by a predetermined level of current in coil 42, the current defining a predetermined electromagnetic force on armature 43 and a characteristic relief pressure. This electromagnetic force can be conveniently selected by automatic controls and calibration methods for different engine applications with differing relief pressure settings, for example.

The safety of a regulator used for high pressure compressed natural gas is important. Accordingly, the relative size of valve port 41 of LP solenoid 17 relative to valve port 22 of HP solenoid 16 is important. In order to limit the pressures in either control space 10 or regulated space 11 under a condition of malfunction of HP solenoid 16 where valve port 22 were to remain open, the ratio of the sizes measured by the nominal cross sectional area limiting the gas flow in each port is to be constrained to a ratio of 10:1 or more. That is, the cross-sectional area limiting the flow of gas through valve port 41 is to be at least 10 times that of valve port 22 when both ports are fully open. This intrinsically limits the maximum pressure in both control space 10 and regulated space 11 in addition to intermediate duct 27 that is the common fluid connection between solenoids 16 and 17. This further protects the solenoids against failure due to bursting by limiting the intermediate pressure in intermediate duct 27 to a value that is at least 10 times lower than the pressure in high pressure supply duct 15 during the aforesaid condition of malfunction.

Unique gas metering systems can be derived by the advanced functions provided by this regulator. Because the pressure provided by the regulator is variable and controllable electronically, it is possible to replace the complex electromagnetically controlled injectors downstream of the regulator with fixed orifice injectors controlling the flow to the intake of the engine. In this example, the control of the gas pressure as a function of engine variables allows for control of the flow of gas to an engine. Thus the fuel flow to the intake manifold of certain large engines can be controlled in response to sensed operating parameters on an engine and by varying the gas pressure using the regulator the fuel delivery to the engine can be controlled in response to required operating variables. Furthermore, by controlling the orifice area downstream of the regulator as a function of selected engine variables, the control of the gas pressure using the regulator is sufficient to control the gas flow accurately to the intake port of a wide variety of engines, whether large or small. The details of such simplified gas delivery systems are out of the scope of the present specification. Such systems are particularly pertinent there liquefied natural gas (LNG) is used as a source of gas. The lack of moving parts in the fuel metering system inhibits or avoids the known problems of rapid wear in using a gas devoid of essentially all lubricating oil, such as that derived from vaporized LNG originally stored at cryogenic temperatures.

While particular elements, embodiments and applications of the present invention have been shown and described, it will be understood, that the invention is not limited thereto since modifications can be made by those skilled in the art without departing from the scope of the present disclosure, particularly in light of the foregoing teachings.

1. A variable gas pressure regulator comprising:
(a) a body provided with an inlet and an outlet;
(b) a control space and a regulated space, said regulated space being fluidly connected to said outlet and being separated from said control space by a diaphragm;
(c) a throttling valve operable to regulate fluid flow between said inlet and said outlet;
(d) a control member associated with said diaphragm to move in response to movements of said diaphragm, said control member being movable to operate said throttling valve; and
(e) a lock-off valve associated with said control member and located in a fluid flow path between said throttling valve and said regulated space, wherein said lock-off valve stops flow of fluid from said inlet to said regulated space when said throttling valve is closed.

2. The variable gas pressure regulator of claim 1, further comprising a first electronically activated valve for controlling flow of fluid from said inlet to said control space and a second electronically activated valve for controlling flow of fluid from said control space to said regulated space.

3. The variable gas pressure regulator of claim 1, further comprising a spring mechanism which acts on said diaphragm to move said control member against the pressure force of the fluid in said control space when the pressure in said control space equals the pressure in said regulated space, whereby said throttling valve and said lock-off valve are urged to respective closed positions.

4. The variable gas pressure regulator of claim 2, further comprising a high-pressure solenoid which is actuated to open or close said first electronically actuated valve and a low-pressure solenoid which is actuated to open or close said second electronically actuated valve.

5. The variable gas pressure regulator of claim 2, wherein said first electronically actuated valve or its associated fluid passage has a cross-sectional fluid flow area that is at least 10 times bigger than the cross-sectional fluid flow area of said second electronically actuated valve or its associated fluid passage.

6. The variable gas pressure regulator of claim 1, further comprising a heating gallery through which a heating fluid can circulate close to said throttling valve to inhibit freezing of said gas pressure regulator.

7. The variable gas pressure regulator of claim 1, further comprising an electrical heating element located close to said throttling valve to prevent freezing of said gas pressure regulator fluid.

8. The variable pressure regulator of claim 1, wherein said throttling valve comprises at least one component made of a metallic material.

9. The variable pressure regulator of claim 1, wherein said lock-off valve comprises a resilient seal for sealing a fluid passage between said inlet to said regulated space.

10. A method of operating a variable gas pressure regulator comprising an inlet, an outlet, a control space and a regulated space which is fluidly connected to said outlet and separated by a diaphragm from said control space, said method comprising:
(a) increasing the pressure in said control space by periodically actuating a first electronically activated valve to open fluid flow between said inlet and said control space thereby moving said diaphragm and a control member associated with said diaphragm to open a throttling valve and a lock-off valve which are associated with said control member to open fluid flow between said inlet and said outlet; and
(b) regulating fluid flow between said inlet and said outlet by actuating a second electronically activated valve to temporarily open fluid flow from said control space to said regulated space if when the pressure in said regulated space exceeds a predetermined pressure thereby urging said throttling valve and said lock-off valve towards their respective closed positions.

11. The method of claim 10, wherein said lock-off valve, in its closed position, further stops flow of fluid from said inlet to said regulated space when said throttling valve is closed.

12. The method of claim 10, wherein a fluid flow rate through said throttling valve and said lock-off valve is determined by the position of said control member.

13. The method of claim 10, wherein said second electronically activated valve opens when the pressure in said control space exceeds a predetermined limit to allow fluid flow from said control space to said regulated space.
